(19) United States
(12) Patent Application Publication
(10) Pub. No.: US 2007/0216845 A1
(43) Pub. Date: Sep. 20, 2007

(54) Uniform impedance conducting lines for a liquid crystal display

(76) Inventors: Chia-Te Liao, Tao-Yuan Hsien (TW); Te-Cheng Chung, Tao-Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/376,206

(22) Filed: Mar. 16, 2006

(51) Int. Cl. G02F 1/1345; G02F 1/1343

(52) U.S. Cl. 349/149; 349/139

(57) ABSTRACT

A liquid crystal display panel with a fanlike shaped conducting line design that provides uniform impedance is disclosed. The liquid crystal display panel comprises a plurality of transistors, a plurality of control ICs and a plurality of conducting lines. Each of the conducting lines comprises a respective width and a respective length. The width and length of the conducting lines increases towards the medial portion of the fanlike shape. The arrangement of the length and width makes the resistance and capacitance of the conducting lines uniform. As a result, the display panel achieves higher optical performance and improved quality.

### BACKGROUND OF THE INVENTION

1. Field of the Invention

The present invention relates to a liquid crystal display panel and, more particularly, to a liquid crystal display panel whose conducting lines for transmitting control signals of the control integrated circuits have uniform resistance and capacitance.

2. Description of Related Art

Liquid crystal displays (LCDs) have gradually replaced cathode ray tubes (CRTs) in the market, and have been more and more appreciated by consumers. Liquid crystal displays not only have the advantage of compactness, but also have lower power consumption. Therefore, they have occupied an important position in almost every field of their application.

As shown in FIG. 1, a conventional LCD panel 16 has several control ICs 10 as its signal input terminals. Each control IC 10 is also connected to a plurality of conducting lines 12 for transmitting control signals to a plurality of transistors 14 arranged in an array. The control ICs are used to control the switching of the transistors 14 and the inputting of data to the transistors 14 so as to produce color display frames.

FIG. 2 is an enlarged view of the conducting line region of FIG. 1. Each conducting line 12 is of the same width but of a different length. Because the lengths of the conducting lines at the left and right sides are longer than that at the center, the resistance and capacitance of the conducting lines increases from the center toward the left and right sides, as shown in FIGS. 3(a) and 3(b). When control signals are input from the control ICs 10, inconsistence of signal on the conducting lines 12 or time delay will occur owing to non-uniform impedance of the conducting lines 12, hence affecting the image quality of the LCD.

In order to solve the above problem, the widths of the conducting lines 12 have been made different (the conducting line at the center is thinner, while the conducting lines at the left and right sides are thicker) to compensate for the non-uniform impedance caused by different lengths, as shown in FIG. 4. Because the active area of the two sides of the ICs is not enough, the design of longer and thicker conducting lines at the left and right sides will make the distance between conducting lines too close which easily results in shorting of the circuit, hence reducing the yield. As indicated in FIG. 4, the spacing between lines 12 is shown as D₁.

Therefore, there is need for an improved liquid crystal display panel which provides conducting lines with identical resistances and capacitances to allow for uniform impedance.

### SUMMARY OF THE INVENTION

To achieve these and other advantages and in order to overcome the disadvantages of the conventional method in accordance with the purpose of the invention as embodied and broadly described herein, the present invention provides a conducting line design used in LCD panels, in which the lengths and widths of the conducting lines are made different to allow each line to have identical impedances. The plurality of conducting lines is formed in a fanlike shape and is used for transmitting control signals of the control integrated circuits (ICs) to the transistors. Each of the conducting comprises a respective width and a respective length. The width of the conducting lines increases towards the medial portion of the fanlike shape. Also, the length of the conducting lines increases towards the medial portion of the fanlike shape. The arrangement of the various lengths and widths make the resistance and capacitance of the conducting lines uniform.

An object of the present invention is to provide an LCD panel capable of producing high quality optical performance.

To achieve the above objects, an LCD panel of the present invention comprises a plurality of transistors, a plurality of control ICs for controlling switching of the transistors and inputting data to the transistors, and a plurality of conducting lines having identical resistances and capacitances for transmitting control signals of the control ICs to the transistors.

The conducting lines are straight lines, oblique lines, bending lines, zigzag shape, wavy shape, or other shape or pattern. Additionally, the conducting lines are one type of line or a combination of lines, shapes, or patterns.

Since the conducting lines have uniform impedance, the optical performance is improved.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing of a conventional liquid crystal display panel;

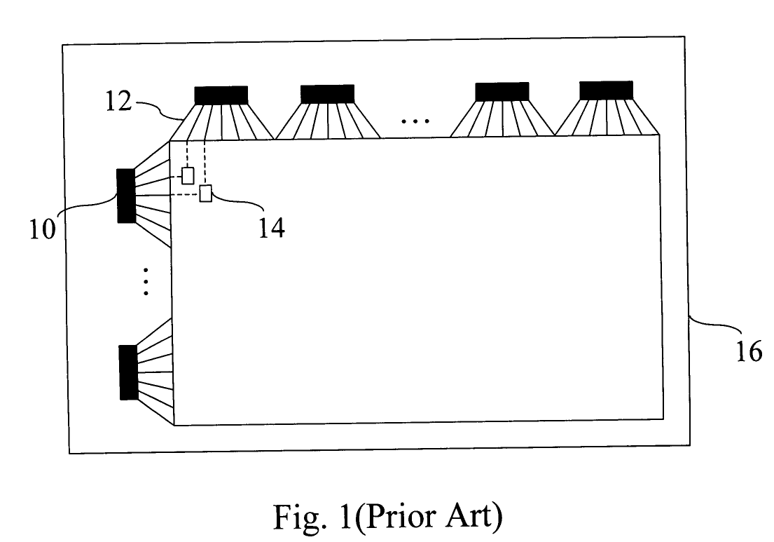

FIG. 2 is an enlarged view of the conducting line region of FIG. 1;

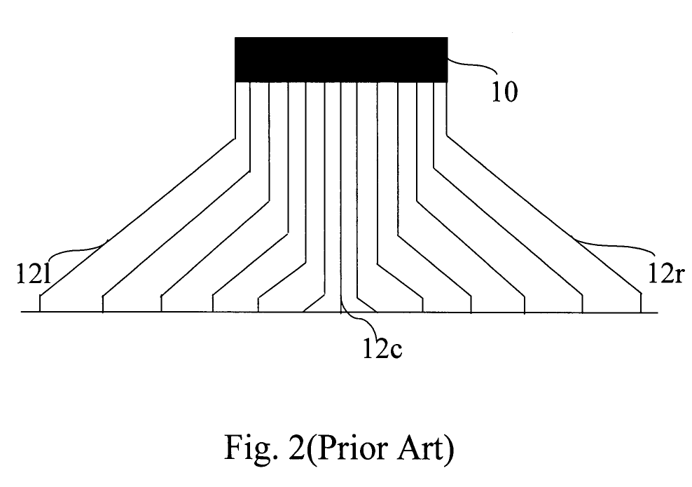

FIGS. 3(a) and 3(b) are diagrams showing the electrical properties of a conventional liquid crystal display panel;

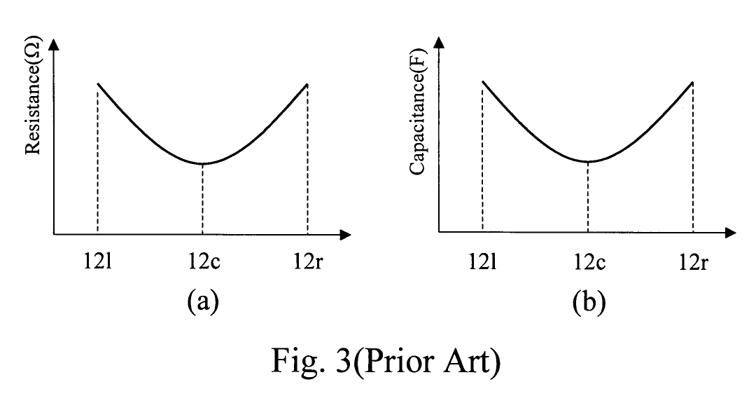

FIG. 4 is a drawing of the conducting lines with different widths in the prior art;

FIG. 5 is a drawing illustrating the conducting lines according to an embodiment of the present invention;

FIG. 6 is a drawing illustrating the conducting lines according to an embodiment of the present invention;

FIG. 7 is a drawing illustrating a liquid crystal display panel according to an embodiment of the present invention;

FIGS. 8(a) and 8(b) are diagrams showing the electrical properties of a liquid crystal display panel according to an embodiment of the present invention; and

FIG. 9 is a drawing illustrating a liquid crystal display panel according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention provides a conducting line design that makes the resistance and capacitance of each conducting line identical. Through change and proper combination of the length and width of each conducting line, the present invention allows the conducting lines to have the same electrical properties, thereby enhancing the image quality of the LCD panel.

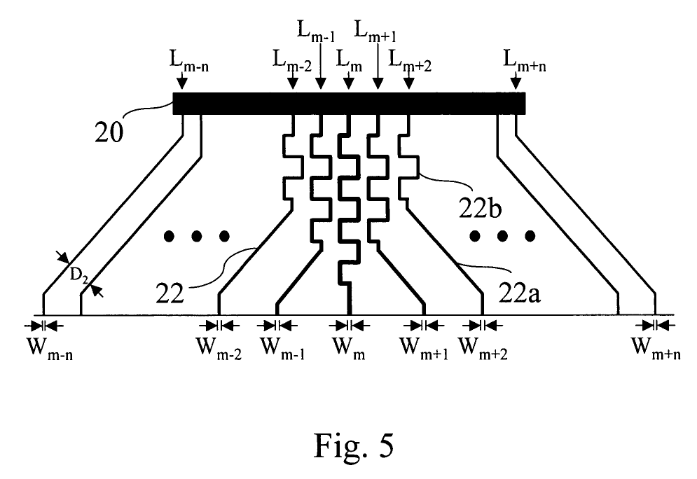

The present invention makes use of impedance compensation to reduce the difference in resistance and capacitance between conducting lines. Refer to FIG. 5, which is a drawing illustrating the conducting lines according to an embodiment of the present invention. Each conducting line 22 comprises a first portion 22a and a second portion 22b. The lengths and widths of the conducting lines are made different to allow each line to have identical impedances. Each of the conducting comprises a respective width and a respective length. The width and length of the conducting lines increases towards the medial portion of the fanlike shape. The arrangement of the various lengths and widths make the resistance and capacitance of the conducting lines uniform.

As shown in FIG. 5, the conducting line in the center of the fanlike shape has a length Lₘ. The first conducting line to the right of center has a length Lₘ₊₁ and the second conducting line to the right of center has a length Lₘ₊₂. Length Lₘ is the longest conducting line length. Lₘ is greater than Lₘ₊₁ which is greater than Lₘ₊₂, etc. The conducting line on the far right has a length of Lₘ₊ₙ, which is the shortest conducting line length.

Similarly, in the direction to the left of center, Lₘ₋₁ is the same length as Lₘ₊₁, Lₘ₋₂ is the same length as Lₘ₊₂, and Lₘ₋ₙ is the same length as Lₘ₊ₙ.

The conducting line in the center of the fanlike shape has a width Wₘ. The first conducting line to the right of center has a width Wₘ₊₁ and the second conducting line to the right of center has a width Wₘ₊₂. Width Wₘ is the largest conducting line width. Wₘ is greater than Wₘ₊₁ which is greater than Wₘ₊₂, etc. The conducting line on the far right has a width of Wₘ₊ₙ, which is the smallest conducting line width.

Similarly, in the direction to the left of center, Wₘ₋₁ is the same width as Wₘ₊₁, Wₘ₋₂ is the same width as Wₘ₊₂, and Wₘ₋ₙ is the same width as Wₘ₊ₙ.

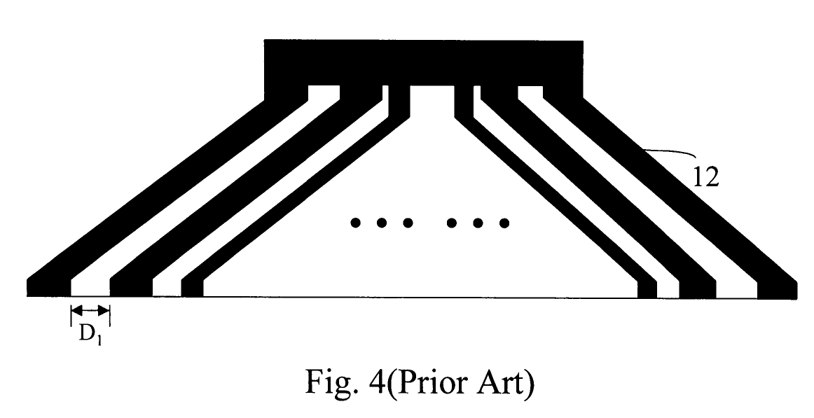

In FIG. 5, the narrowest distance between the conducting lines is indicated by D₂. This distance D₂ is larger than the distance D₁ shown in FIG. 4. This illustrates that the conducting line design of the present invention is superior at preventing short circuits between conducting lines.

The first portion 22a of the conducting line can be a straight line, an oblique line, or a combination of straight line and oblique line to avoid the problem of a too close distance between conducting lines. Because the resistance of the conducting line 22 is inversely proportional to its cross sectional area and proportional to its length, the conducting lines 22 are arranged with the various lengths and widths in order to provide identical resistances and capacitances.

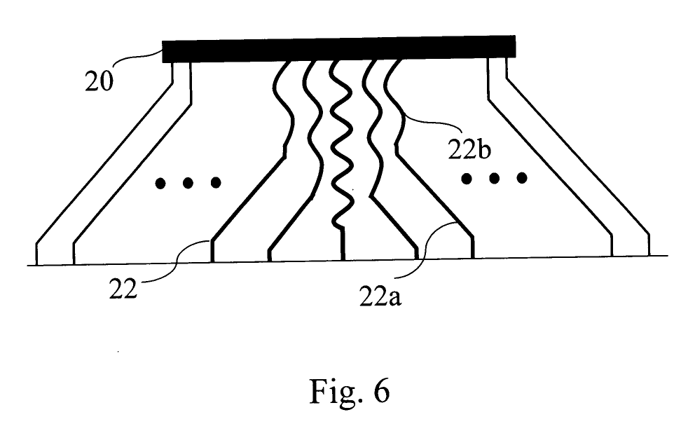

Refer to FIG. 6, which is a drawing illustrating conducting lines according to an embodiment of the present invention, in which the second portions 22b are arranged together with the first portions 22a, and the second portions 22b are arranged in a wavy shape. Alternatively, the second portions 22b can be arranged in a specific shape to match the circuit layout.

In FIG. 5 and FIG. 6, the second portions 22b of the two conducting lines at the left and right sides are straight. Similarly, they can also be of a zigzag, wavy shape, or other shape or pattern.

The design of conducting lines in the above embodiments uses the resistance of the central conducting line 22 as a reference standard. First the width and length of the center conducting line is designed, and then the impedance of conducting lines 22 to the left and right sides of the center are made identical to the standard. Therefore, the widths and lengths of the conducting lines gradually decrease from the center toward the left and right sides.

Alternatively, another conducting line 22 (e.g., the outmost conducting line) can also be chosen as a reference standard for impedance compensation, and the widths and lengths of the conducting lines are changed accordingly from outside to inside to allow each conducting line to finally have identical resistances and capacitances.

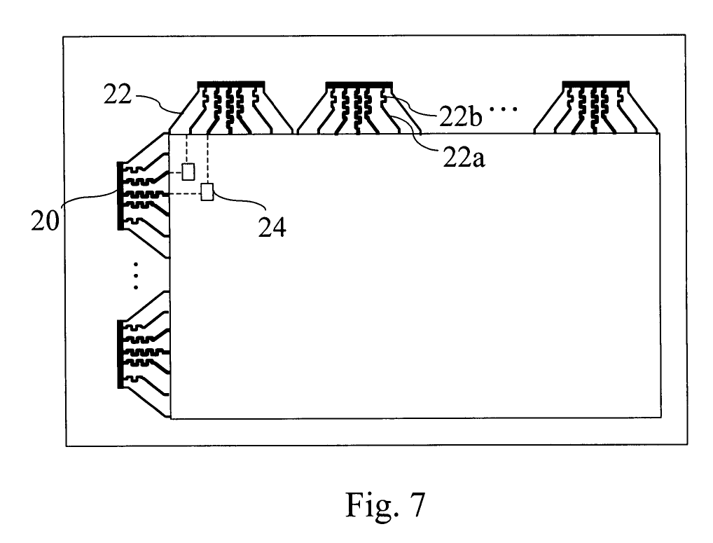

The present invention further provides an LCD panel that utilizes the above conducting line design. Refer to FIG. 7, which is a drawing illustrating a liquid crystal display panel according to an embodiment of the present invention. The LCD panel comprises a plurality of transistors 24, a plurality of control ICs 20 for controlling switching of the transistors 24 and inputting data to the transistors 24, and a plurality of conducting lines 22 for transmitting control signals of the control ICs 20 to the transistors 24.

The gates of the transistors 24 are connected to the conducting lines 22 in the horizontal direction, and the drains of the transistors 24 are connected to the conducting lines 22 in the vertical direction. The conducting lines 22 in the horizontal direction are responsible for transmitting signals for controlling switching of the transistors 24. The control ICs 20 will turn on a row of transistors 24 each time, and send data into each transistor 24 in the row via the conducting lines 22 in the vertical direction, and then turn off the transistors 24. Data read in at this time will be stored in the transistors 24 in the form of charge until the control ICs 20 turn on the transistors 24 and store other data into the transistors 24.

Next, the control ICs 20 will turn on the next row of transistors 24, and input data into each transistor 24 in the row, and then turn them off. All the transistors 24 will undergo the above steps in order, and the whole frame data are thus stored into the corresponding transistors 24 and displayed on the panel. Alternatively, a conducting line 22 for transmitting data can be connected to more than one transistor 24, but these transistors 24 are controlled by different switching signals. Therefore, the sane conducting line 22 can be selected to transmit data to several transistors 24, thereby reducing the number of conducting lines and also lowering the cost.

Each conducting line 22 comprises a first portion 22a and a second portion 22b. The widths of the conducting lines 22 gradually increase from the left and right sides toward the medial portion, and the lengths of the conducting lines 22 gradually increase from the left and right sides toward the medial portion. The first portion 22a can be a straight line, an oblique line, or a combination of straight line and oblique line to avoid the problem of a too close of distance between conducting lines Also, the shape or pattern of the second portion 22b can be selected according to requirements.

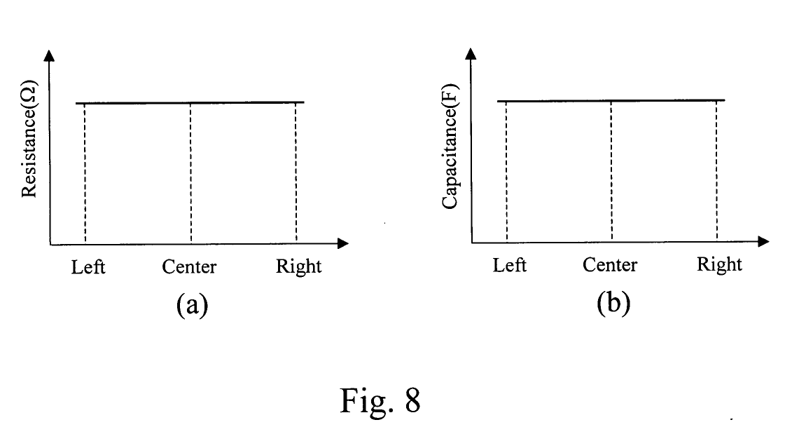

This design can allow the conducting lines 22 for transmitting control signals and data signals to have the electrical properties curve shown in FIGS. 8(a) and 8(b), in which “left”, “center” and “right” represent the conducting lines at the left side, the center and the right side, respectively. Because each conducting line 22 in the figures has the same resistance and capacitance, the control signals that pass through won't have any inconsistency or delay phenomenon. Signals can be simultaneously transmitted to each controlled transistor 24 to maintain the wholeness of data to be displayed, thereby producing a display frame of high image quality.

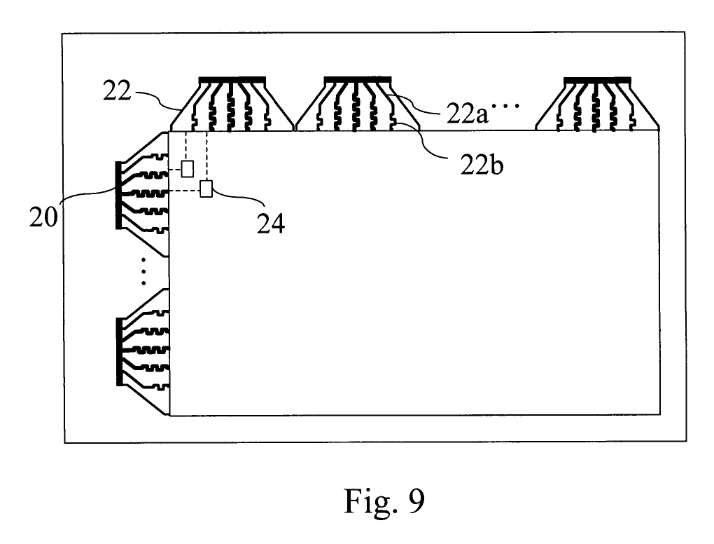

In the above embodiment, the first portions 22a of the conducting lines 22 are connected to the transistors 24 of the LCD panel, and the second portions 22b are connected to the control ICs 20. The connection can also be reversed, as shown in FIG. 9, wherein the first portions 22a are connected to the control ICs 20, and the second portions 22b are connected to the transistors 24.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A conducting line design for a liquid crystal display panel, comprising:
a plurality of conducting lines formed in a fanlike shape for transmitting control signals, wherein each of the conducting lines comprises a respective width and a respective length, the width and length of the conducting lines increasing towards a medial portion of the fanlike shape, the arrangement of length and width making resistance and capacitance of the conducting lines uniform.

2. The conducting line design for a liquid crystal display panel as claimed in claim 1, wherein the conducting lines are straight lines, oblique lines, or a combination of straight lines and oblique lines.

3. The conducting line design for a liquid crystal display panel as claimed in claim 1, wherein the conducting lines are arranged in a bending pattern.

4. The conducting line design for a liquid crystal display panel as claimed in claim 3, wherein the bending pattern is a zigzag shape or a wavy shape.

5. The conducting line design for a liquid crystal display panel as claimed in claim 1, wherein the conducting lines comprise a straight portion and a bending portion.

6. The conducting line design for a liquid crystal display panel as claimed in claim 1, the conducting lines further comprising a first portion and a second portion.

7. The conducting line design for a liquid crystal display panel as claimed in claim 6, wherein the first portion is connected to a transistor, and the second portion is connected to a control IC.

8. The conducting line design for a liquid crystal display panel as claimed in claim 1, further comprising:
a plurality of transistors; and
a plurality of control integrated circuits for controlling switching of the transistors and inputting data to the transistors, wherein the conducting lines are used for transmitting control signals of the control integrated circuits to the transistors.

9. A liquid crystal display panel comprising:
a plurality of transistors; a plurality of control integrated circuits for controlling switching of the transistors and inputting data to the transistors; and
a plurality of conducting lines formed in a fanlike shape for transmitting control signals of the control integrated circuits to the transistors,
wherein each of the conducting lines comprises a respective width and a respective length, the width of the conducting lines increasing towards a medial portion of the fanlike shape and the length of the conducting lines increasing towards the medial portion of the fanlike shape, the arrangement of the length and the width making resistance and capacitance of the conducting lines uniform.

10. The liquid crystal display panel as claimed in claim 9, wherein the conducting lines are straight lines, oblique lines, or a combination of straight lines and oblique lines.

11. The liquid crystal display panel as claimed in claim 9, wherein the conducting lines are arranged in a bending pattern.

12. The liquid crystal display panel as claimed in claim 11, wherein the bending pattern is a zigzag shape or a wavy shape.

13. The liquid crystal display panel as claimed in claim 9, wherein the conducting lines comprise a straight portion and a bending portion.

14. The liquid crystal display panel as claimed in claim 9, the conducting lines further comprising a first portion and a second portion.

15. The liquid crystal display panel as claimed in claim 14, wherein the first portions are connected to the transistors, and the second portions are connected to the control ICs.
